(19) United States
(12) Patent Application Publication
(10) Pub. No.: US 2020/0183737 A1
(43) Pub. Date: Jun. 11, 2020

(54) COORDINATING PROCESSES WITH INTERFERING EXTERNAL ACTIONS

(71) Applicant: HEWLETT PACKARD ENTERPRISE DEVELOPMENT LP, Houston, TX (US)

(72) Inventors: Peter Michael Bruun, Alleroed (DK); Jane Koenigsfeldt, Alleroed (DK); Mads Stenhuus, Alleroed (DK)

(21) Appl. No.: 16/212,970

(22) Filed: Dec. 7, 2018

(51) Int. Cl. G06F 9/48; G06F 9/50

(52) U.S. Cl. CPC G06F 9/4881; G06F 9/5005

(57) ABSTRACT

A method including developing a representation of a set of services where each service relates to other services via different types of relationships and applying a set of dependency rules for each type of relationship within the set of services such that the application of the dependency rules creates inter-step dependencies between state transitions of the set of services. The method further including developing a step graph for the set of services based on the inter-step dependencies, identifying a common step in the step graph that is relevant to a first process and a second process, and removing any steps from the step graph for the first process that are relevant to the second process and not relevant to the first process.

### BACKGROUND

Orchestration defines policies and service levels through automated workflows, provisioning, and change management. Uses of orchestration may be discussed in the context of service-oriented architecture, virtualization, provisioning, converged infrastructure, telecommunications, and datacenter topics. As such, orchestration provides centralized management of computing resources that allows for management, including the ability to create, configure, remove, or otherwise modify applications for a defined purpose.

### BRIEF DESCRIPTION OF THE DRAWINGS

Examples described herein may be understood by reference to the following description taken in conjunction with the accompanying drawings, in which like reference numerals identify like elements.

FIG. 1 is a schematic representation of a compute system in accordance with one or more example embodiments.

FIG. 2 is a state model in accordance with one or more example embodiments.

FIG. 3 is a representation of service relationships in accordance with one or more example embodiments.

FIG. 4 is a representation of a system architecture to develop an orchestration plan in accordance with one or more example embodiments.

FIG. 5 is a representation of a step graph in accordance with one or more example embodiments.

FIG. 6 is a step graph for a main service object in accordance with one or more example embodiments.

FIG. 7 is a schematic representation of the comparison of two processes in accordance with one or more example embodiments.

FIG. 8 is a user interface in accordance with one or more example embodiments.

FIG. 9 is a service graph for processes in accordance with one or more example embodiments.

FIG. 10 is an expanded service graph of FIG. 9 in accordance with one or more example embodiments.

FIG. 11 is a flow diagram of a method of preventing interferences in an orchestration plan concurrently in accordance with one or more example embodiments.

FIG. 12 is an example computing device with a hardware processor and accessible machine-readable instructions in accordance with one or more example embodiments.

FIG. 13 is a schematic representation of a computer processing device that may be used to implement functions and processes in accordance with one or more example embodiments.

While examples described herein are susceptible to various modifications and alternative forms, the drawings illustrate specific examples herein described in detail by way of example. It should be understood, however, that the description herein of specific examples is not intended to be limiting to the particular forms disclosed, but on the contrary, the intention is to cover all modifications, equivalents, and alternatives falling within the spirit and scope of the examples described herein and the appended claims.

### DETAILED DESCRIPTION

One or more examples are described in detail with reference to the accompanying figures. For consistency, like elements in the various figures are denoted by like reference numerals. In the following detailed description, specific details are set forth in order to provide a thorough understanding of the subject matter claimed below. In other instances, well-known features to one of ordinary skill in the art having the benefit of this disclosure are not described to avoid obscuring the description of the claimed subject matter.

Orchestration provides a process of actions directed toward achieving larger goals and objectives defined in a service orchestration request. Service orchestration may include composing architecture, tools, and processes, stitching software and hardware components together, and connecting and automating workflows when applicable to deliver a defined service. The introduction of new applications may consume greater resources, and this level of consumption may be alleviated by automated tools. These automated tools, by way of orchestration, can perform tasks previously handled by multiple administrators operating on individual pieces of a physical stack. Serializing state models indicates a sequence of events based on modification of one or more nodes of the model. Serializing dependency graph models have been solved for simplistic decomposition model and state-less models; however for more complex graph models, solutions may be limited in solving all possible model transformations.

“Services” as explained herein, refers to the orchestration of changes in a complex system including interactive services, networks, and systems for the creation of communication services.

One solution uses ad-hoc decomposition methods and queue-based execution plans. For example, machine code executable by a processor may push action queues in an order intended to generate the correct sequence of actions. This solution results in unpredictable instances and may be unable to handle complex re-creations of specific uses cases. For example, using decomposition methods and queue-based executions are limiting when going through state-transitions that effectively tear down and re-create parts of a configuration topology. Additionally, ad-hoc approaches may be unable to detect conflicting requirements which may lead execution engines to make unpredictable arbitration decisions. Unpredictable arbitration decisions result in an unstable end-to-end orchestration solution as the solution becomes untestable.

A second solution uses models declared as graph templates, referred to as the Topology and Orchestration Specification for Cloud Applications (“TOSCA”) Organization for the Advancement of Structured Information Standards (“OASIS”) standard language. In the TOSCA OASIS solution, standard language is used to describe a topology of cloud-based web services, their components, relationships, and the processes that manage the web services. The resulting models in this solution are static and may not be modified. Modifications to the resulting models institute a tear-down and recreation of the full model and components. This solution becomes a challenge in the situations where downtime is undesirable.

A third solution uses services defined by hierarchical decomposition which is a type of simplified model. In the hierarchical decomposition, a hierarchical decision process is used to evaluate a sequence of actions; however, this solution may not capture graph structured services, as modifications to the hierarchy structure would elicit a redesign of the full structure. In this example, the hierarchical decomposition solution is more of a static approach, not providing modifications as changes to services occur, and as such, may be unable to handle changes that span the hierarchy without a full redesign. In another example of the hierarchical decomposition, a tree model may be used to represent a relationship between services. In such a model, each node in the structure may include a parent node and/or child node. From a modeling perspective, tree structures are simpler that other decomposition and state-models. Such models fail to account for the more difficult and complex models that include various interdependencies between the nodes of the tree. In certain situations, the nodes may share no commonality.

Another solution uses a simplistic state-model in which the various states of a service are interdependent on one another. In this solution, a node in a graph is represented in the state as fully configured or non-existent. This approach reduces the problem of modeling the dependencies between states of related nodes in the graph; however, is unable to handle the complexity of external system configurations.

Additionally, multiple processes may become entangled within a particular task. Certain processes may perform different, potentially contradicting interactions, with the same external systems or users, thereby resulting in interfering processes. Such entangled and/or interfering processes may provide security risks because the processes for particular tasks become grouped incorrectly. As such, data for one user, company, or the like may be comingled with data for a second user, company, etc. Comingling of such data may thereby give access to the data to parties that should not receive such data.

Accordingly, methods and systems of the present disclosure may provide methods to identify and remove parts of remaining steps of one or more processes that either need to be removed entirely or otherwise reassigned to other remaining processes.

More specifically, the present disclosure develops a representation of a set of services such that the representation includes how the set of services relate to one another by different types of relationships. Based on the relationships, a set of dependency rules is applied for each type of relationship in the representation. In response to the application of the set of dependency rules, inter-step dependencies are created between state transitions for the set of services. From the inter-step dependencies, as well as a request to modify the services, a step graph may be generated for the set of services based on the creation of the inter-step dependencies. During the operation of the system, a common step may be identified within the step graph that belongs to two or more processes. Upon identification of the common step, any steps in the step graph for the first process that belong to the second process may be removed. Accordingly, steps that do not belong to particular services can be removed if they are not required to achieve the objective of the request to modify the services/processes and there is another process with the same steps and the steps are required to achieve the objective of the process.

Prior to a detailed discussion of how potentially interfering steps may be removed from a process plan, a background discussion of forming the step graph and identifying dependencies between services is provided.

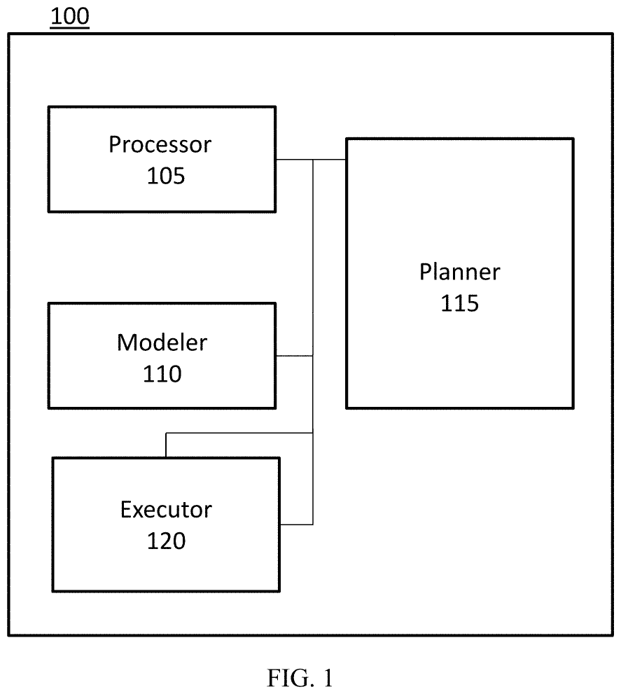

Turning to FIG. 1, a schematic representation of a system for fulfilling services according to one or more examples is shown. In such a system 100, a processor 105 is connected to a modeler 110 and a planner 115. In certain systems 100, more than one processor 105 may be connected to modeler 110 and/or planner 115. The processor 105 may include a virtual device or a physical device such as electronic circuitry that includes an integrated circuit, programmable circuit, application integrated circuit, controller, processor, semiconductor, processing resource, chipset, or another type of component capable of managing system 100.

The modeler 110 builds a model (not shown) that represents a set of services and relationships between such services. The model may be used as an input to planner 115, which may apply dependency rules to define the different types of relationships between the services. Examples of relationships may include two or more services being related as siblings, whereby the services may operate concurrently and not rely on each other. Other types of relationships may include parent-child relationships, whereby the child service may rely on the parent service. In such a parent-child relationship, the child service may not be executed until the parent service is completed. The application of dependency rules thereby creates inter-service dependencies between certain services within a set of services. Creating inter-service dependencies allows planner 115 to develop an orchestration plan that includes a step graph that defines an order of execution for particular services. As will be discussed in detail below, the step graph may allow for the execution of nondependent services concurrently. Modeler 110 may be a physical device such as electronic circuitry that includes an integrated circuit, programmable circuit, application integrated circuit, controller, processor, semiconductor, processing resource, chipset, or another type of component capable of managing system 100. Alternatively, modeler 110 may include instructions, e.g., stored on a machine-readable medium, that when executed by processor 105 builds the model. Implementations of the model may include stat models, a multi-technology operations system interface model (“MTOSI”), conception models, mathematical models, computer models, or other types of models that illustrate the inter-connectedness of the set of services to each other by the differing types of relationships.

The planner 115 may use the model as provided by modeler 110 to apply dependency rules to create inter-service dependencies between the various services. Based on the creation of the inter-service dependencies, planner 115 may proceed to develop an orchestration plan. In certain implementations, planner 115 may develop a step graph, as will be illustrated in detail below, prior to development of the orchestration plan. Planner 115 may thereby use the model to determine whether specific services are dependent or nondependent. Planner 115 may be a physical device such as electronic circuitry that includes an integrated circuit, programmable circuit, application integrated circuit, controller, processor, semiconductor, processing resource, chipset, or another type of component capable of managing system 100. Alternatively, planner 115 may include instructions, e.g., stored on a machine-readable medium, that when executed by processor 105 develop the orchestration plan.

Dependency rules may be used to define the different types of relationships between services created in the model. For example, a set of dependency rules may apply to parent types of relationships. Another set of dependency rules may apply to child relationships, sibling relationships, or other relationships defined herein. Examples of relationships may include two or more services being related as siblings, whereby the services may operate concurrently and not rely on each other. Other types of relationships may include parent-child relationships, whereby the child service may rely on the parent service. In such a parent-child relationship, the child service may not be executed until the parent service is completed. The application of dependency rules by planner 115 results in inter-service dependencies between different state transitions in a set of services. To produce the inter-service dependencies for the state transitions, dependency rules may include a set of principles that define the state transitions for the different types of relationships within system 100.

An orchestration plan is produced by planner 115 upon creation of the inter-service dependencies. The orchestration plan defines an order for which services will be executed. Because of the creation of the inter-service dependencies, the orchestration plan allows nondependent services to be identified so that the execution of certain services may proceed in parallel, thereby allowing certain nondependent services to be executed concurrently.

System 100 may further include an executor 120, that executes the devised orchestration plan. The executor 120 may receive revised orchestration plans from planner 115 as the plans are revised based on automatically generated modifications or user input. Executor 120 may be a physical device such as electronic circuitry that includes an integrated circuit, programmable circuit, application integrated circuit, controller, processor, semiconductor, processing resource, chipset, or another type of component capable of managing system 100. Alternatively, executor 120 may include instructions, e.g., stored on a machine-readable medium, that when executed by processor 105 executes the orchestration plan.

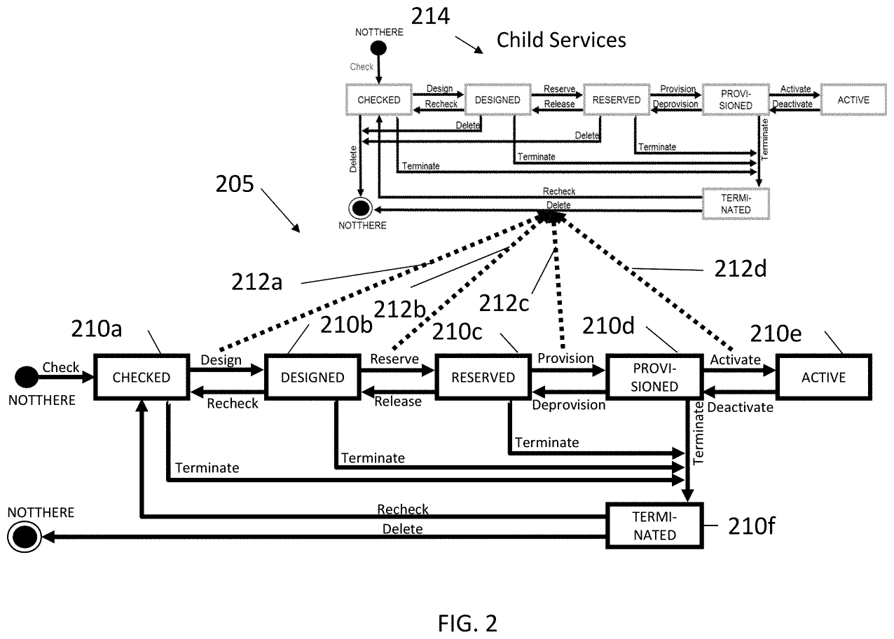

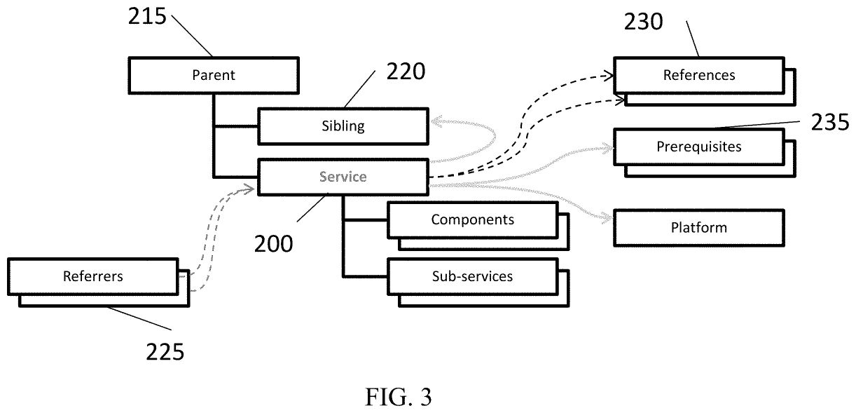

Turning to FIG. 2, a state model according to one or more examples is shown. State model 205 illustrates potential state transitions 210a-210e for a given service. State model 205 is represented as a MTOSI that includes initial state transition 210a and potential state transitions 210b-210f. This model may be used by service providers as a mechanism to manage complex networks and corresponding services (200 of FIG. 3). In other implementations, state model 205 may include conceptual models or other visual depictions representing various states of a given service. State model 205 may further provide a visual depiction of the inter-relatedness of the set of services by rendering possible state transitions 210a-210f.

In this implementation, the application of the dependency rules creates inter-service dependencies 212a-212d. Inter-service dependencies 212a-212d are dependencies that exist between state transitions between the services, which in this example are the given service (represented by state model 205) and related child services 214. In this example, the given service transition from state “checked” 210a to “designed” 210b creates inter-service dependency 212a that depends on a state transition (not illustrated) in child services 214. In another example, the given state transition from “designed” 210b into “reserved” 210 has dependence 212b to another state transition (not illustrated) in child services 214. In yet another example, the state transition from “reserved” 210c into “provisioned” 210d has inter-service dependency 212c to another state transition corresponding to child services 214. In one more example, the state transition for the given service from “provisioned” 210d into “active” 210e has inter-service dependency 212d to another state transition corresponding to child services 214. Accordingly, application of the dependency rules creates the inter-service dependencies 212a-212d between multiple services that are related. While only a parent-child dependency is discussed herein, inter-service dependencies 212a-212d may be created for all services in a system. Such state models 205 may thus be created for each dependency relationship with a system. Specific examples of the types of dependency rules that may be applied are explained in detail below.

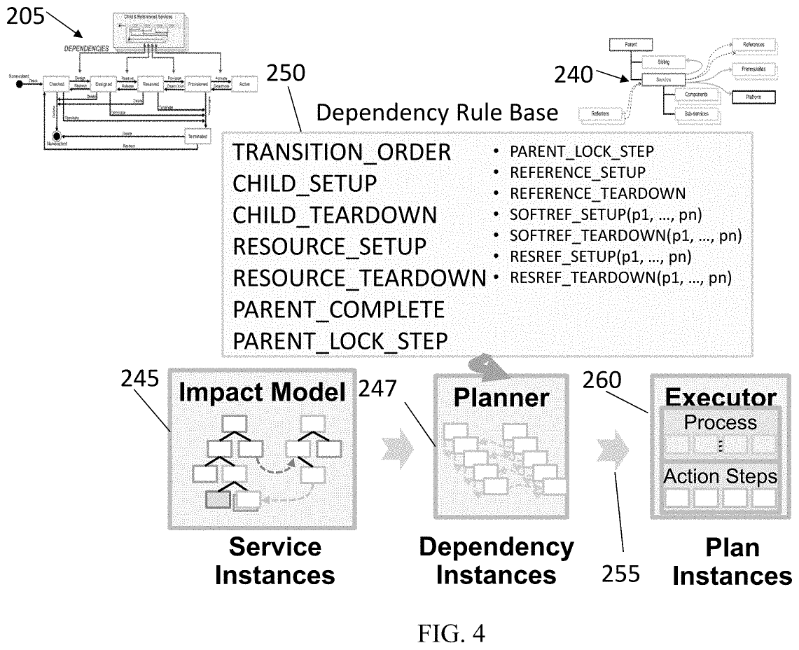

Turning to FIG. 3, a representation of service relationships according to one or more examples is shown. The different types of relationships between services 200 may include, for example, parent, sibling, referrers, references, prerequisites, and the like. The arrows represent the relationship of a given service 200 to other services. For example, there is a parent service 215 to given service 200. There is also a sibling service 220 to service 200, wherein sibling service 210 also has a relationship as a child to parent service 215. Defining the relationships between the services allows the order in which particulars services may be completed to be graphically represented. In this example, service 200 may have to wait for parent service 215 to complete before it may begin. Sibling service 220 may also have to wait for parent service 215 to complete before it begins, however, sibling service 220 may execute at the same time as service 200. Additional services may include referrers 225 to given service 200, as well as reference service 230 and any number of prerequisite services 235 to given service 200. The state model developed in FIG. 2 may also include different types of relationships between given service 200 and other services. Depending on the type of relationship, a set of dependency rules may be applied to the different types of relationships to create inter-service dependencies illustrated in FIG. 4.

Turning to FIG. 4, a representation of a system architecture to develop an orchestration plan according to one or more examples is shown. U 4 shows how a service 210 relates to other services via different types of relationships (e.g., parent, sibling, child, referrer, pre-requisite, references, etc.). Impact model 245 may develop a model that is used by the planner. The planner applies dependency rules 250 which are specific to the different types of relationships. By applying dependency rules 250, the planner creates inter-service dependencies between the given service and other services as represented by 240.

Creating the inter-service dependencies, the planner creates a step graph (not illustrated). Examples of step graphs are discussed in later figures. Using the step graph, the planner may apply a topological sorting algorithm 255 to obtain a list of state transitions for execution by the executor 260. An example of a topological sorting algorithm that may be used includes Tarjan's Algorithm. The list of state transitions is developed by an orchestration plan (not illustrated). In an example implementation, the orchestration plan includes the sequenced order of state transitions for execution. Implementations of the modeler 245 and the executor 260 include electronic circuitry (i.e., hardware) such as an integrated circuit, programmable circuit, application integrated circuit (ASIC), controller, processor, semiconductor, processing resource, chipset, or other type of hardware component capable of building model 240 and developing the list of state transitions in which to execute. Alternatively, components 245 and 260 may include instructions (e.g., stored on a machine-readable medium) that, when executed by a hardware component (e.g., controller and/or processor) builds a model and develops the sequenced order of state transitions, accordingly.

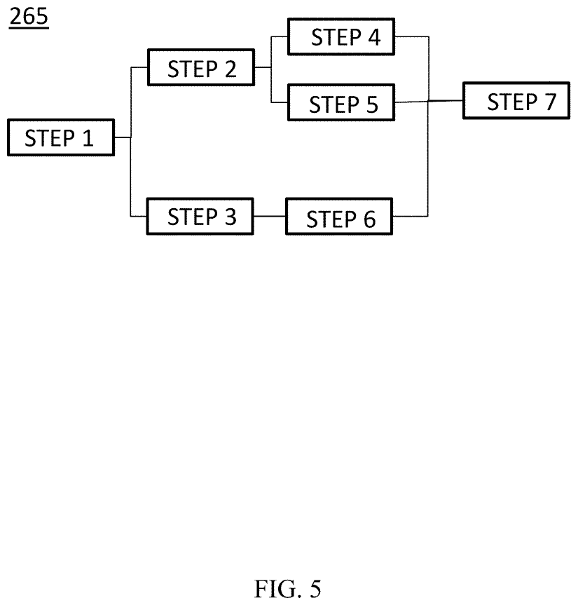

Turning to FIG. 5, a step graph according to one or more examples is shown. Step graph 265 is illustrative of a single process that is working on one or more services, where the process includes various steps having specific dependencies. The specific steps are executed in a particular order based on, for example, their transitive relationship. In this example, step 1, must be completed before any further steps are completed. After the completion of step 1, steps 2 and 3 may begin. After the completion of step 2, steps 4 and 5 may begin, while after the completion of step 3, step 6 may begin. Upon the completion of steps 4, 5, and 6, step 7 may begin. While only seven steps are identified, in practice, tens, hundreds, or thousands of steps may be present in such a step graph 265. Additionally, depending on the specifics of the operation, other progressions of steps may occur. For example, in certain examples, steps 2 and 3 may be required to complete before steps 4, 5, and 6 can proceed. Those of skill in the art having benefit of the present disclosure will appreciate that the specific operational aspects of step graph 265 are not a limitation on the scope of the present disclosure.

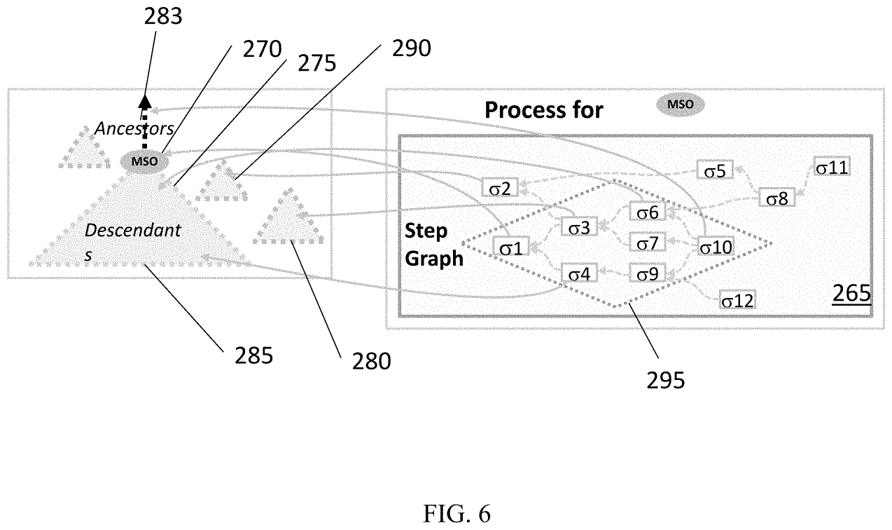

Turning now to FIG. 6, a step graph for a main service object according to one or more examples is shown. In this illustration, each step, i.e., steps σ1-σ11, in step graph 265 is related to one service of a main service object (“MSO”) 270. The steps can execute an action on the service to which it pertains. For example, step σ1 can execute an action for service 275, while step σ3 can execute an action for service 280. This is the same for the remaining steps in step graph 265, and the relationships between the steps and the services are illustrated as arrows connecting specific steps to specific services.

Step graph 265 can be topologically sorted as a list, and the steps can be illustrated as coming before, after, or last relative to each other step in the sorted list. An example sorted list is discussed in detail below. In certain circumstances, the steps pertain to the MSO 270, its ancestors 283, or descendants 285. For example, step σ4 pertains to descendant 285. However, in other circumstances certain steps may pertain to services not pertaining to MSO 270. In this example, step σ2 pertains to other service 290. One of the steps is referred to as the Last Modified Service (“LMS”), which is the last step that is related to a service pertaining to MSO 270. In this example, the LMS is step σ10, as it is the last step that is an ancestor to MSO 270.

Since step σ6, which pertains to MSO 270 depends on step σ3, which pertains to another service 295, step σ3 is a necessary step for the rest of the process to complete for MSO 270. Steps that depend on a prior step are included in box 295, which includes steps σ1, σ3, σ4, σ6, σ7, σ9, and σ10. Certain steps are independent of the steps in box 295 because they may complete without regard to the steps identified therein. In this example, the independent steps include steps σ2, σ5, σ8, σ11, and σ12. While independent, the steps may still be related to services that also have steps in other processes.

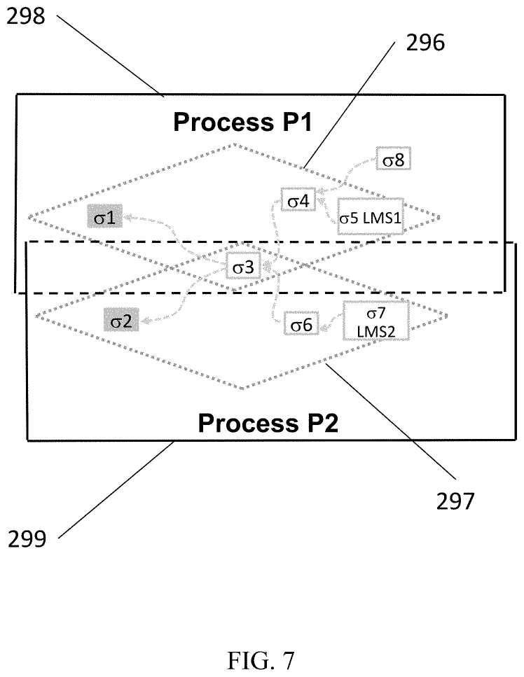

To determine whether certain steps may be removed, multiple processes may be compared. The process for determining which steps may be removed is illustrated below in FIG. 7.

Turning to FIG. 7, a schematic representation of the comparison of two processes according to one or more examples is shown. In this representation, two processes are identified, a first process (P1) 298 and a second process (P2) 299. Steps σ1 and σ2 are the first steps that require completion for their respective processes. In certain implementations, steps σ1 and σ2 may be completed concurrently, but in other implementations they may complete at different times. Two dependent groupings, including steps that rely on one another are shown in boxes 296 and 297. As illustrated, steps σ1, σ3, σ4, and σ5 pertain to first process 298. Similarly, steps σ2, σ3, σ6, and σ7 pertain to second process 299. As such, the steps σ2, σ6, σ7, and σ8 are independent of first process 298, while steps σ1, σ4, σ5, and σ8 are independent of second process 299. Both groups include a common step σ3.

When common step σ3 is completed, and assuming that first process 298 was the process that completed the step, first process 298 determines that steps σ6 and σ7 are relevant to another process, i.e., second process 299. Relevancy of specific steps to specific processes may indicate that the steps are required or otherwise necessary for the process to complete. A step that is not relevant to a process may thus include a step that is not necessary for the process to complete. For example, steps σ6 and σ7 are relevant to second process 299, but not relevant to first process 298. After determining the relevancy of steps σ6 and σ7, first process 298 may then eliminates steps that are not relevant to first process 298, in this example, steps σ6 and σ7. First process 298 then determines that step σ8 does not belong to another process, so step σ8 is kept within first process 298. In this instance, step σ8 is referred to as an “orphaned step” because it does not belong to a specific process. While in this implementation first process 298 picks up step σ8, in other embodiments, other processes, including processes not specifically identified herein may pick up and process step σ8. First process 298 then executes steps σ4, σ5, and σ8 and continues the overlapping second process 299. As such, when the common step σ3 completes, the steps that are not shared between first and second processes 298 and 299 may be disassociated.

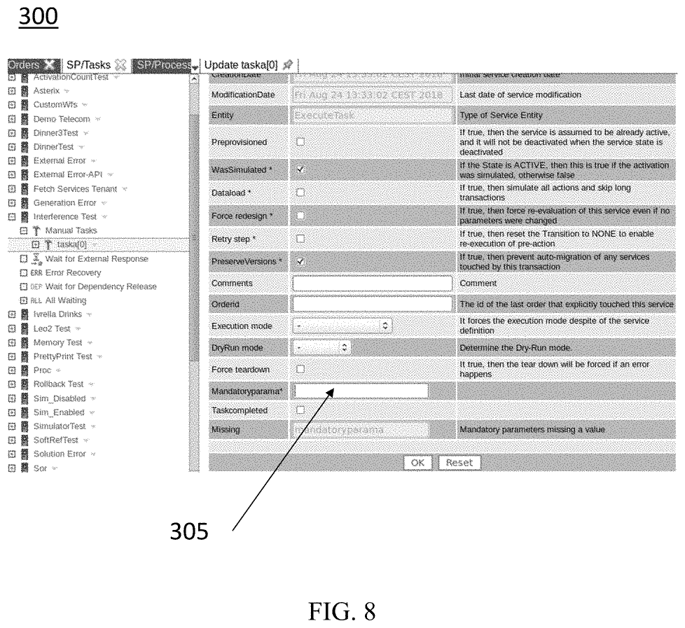

The process of determining and eliminating overlapping processes in orchestration plans will be described with respect to an example implementation in FIGS. 8, 9, and 10.

Turning now to FIG. 8, a user interface view of a manual task according to one or more examples is shown. In this illustration, a user interface 300 may include a graphical user interface that includes a task view for creating or otherwise modifying system resources. In this example, a resource is being created that includes a manual task called mp1.taska, that requires a user to provide a parameter, e.g., Mandatory parama 305. The task that is generated may be for creating a shared resource/service. For example, the user may be required to perform a required task, such as installing a cable into a computing system, providing data to a system, and/or performing other potential hardware and/or software modifications to computing equipment. Using the task view, the user may further indicate that the task is compete, thereby indicating that no more action needs to be taken with respect to the particular task.

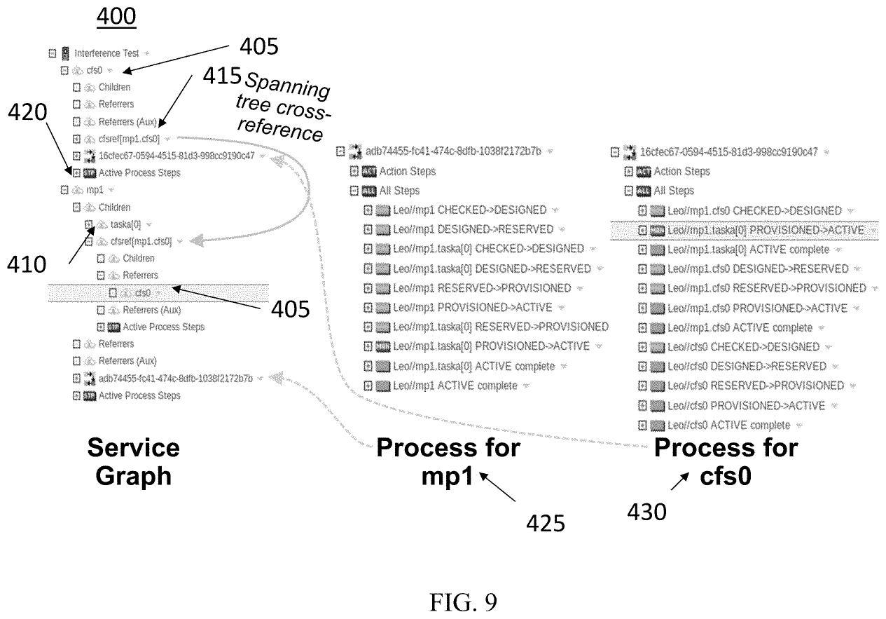

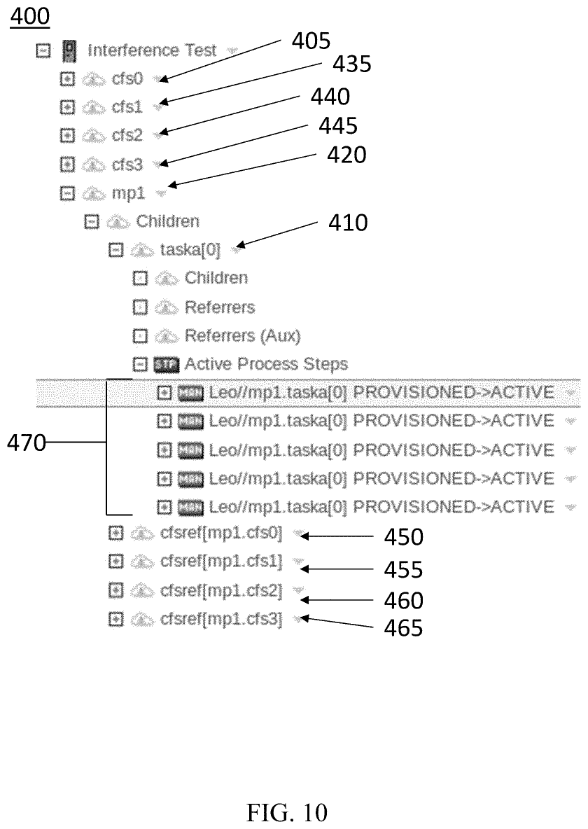

Turning to FIG. 9, a service graph showing processes for a system according to one or more examples is shown. Service graph 400 may be a graphical representation of data otherwise collected and provided in the step graph. In this example, which will be continued with respect to FIG. 10, an example of the generation of an interfering process is illustrated and the removal of such interfering process is discussed.

A customer facing service (“CFS”) defines the properties of a specific service related to particular products in a system infrastructure that interacts with a customer. In some implementations, the customer may be an entity, such as a corporation, that owns and pays for the service. In other implementations, the customer may be other types of entities or individuals. In certain situations, the services may represent customer-ordered services, however, in other circumstances the service may be closer to the actual infrastructure and not represent customer-ordered services. T

In this example, a CFS is used to create cfs0, 405, a service added by a user. The service cfs0, 405, is created to add a configuration to “taska” 410, which is a resource tied to a particular service. Taska 410 will be discussed in detail with respect to FIG. 7. The configuration is added as mp1.cfs0, 415, and requires the completion of taska 410. After addition, mp1.cfs0, 415, shows up twice within service graph 400. As such, cfs0, 405 has a cross-reference across service graph 400 to mp1.cfs0, 415. Service graph 400 also shows process mp1, 420. Process mp1, 420, is likewise cross-referenced to cfs0, 405, as they share a common process step. The cross-referencing is the result of a topology analysis, such as that explained above, that shows their spanning tree relationship connects cfs0, 405, and mp1, 420.

The processes for mp1, 420, are illustrated as a set of action steps at 425. Similarly, the processes for cfs0, 405, are illustrated as a set of action steps at 430. The processes for mp1 and csf0, 425 and 430, respectively, include a number of processes that must be completed by taska 410, before additional processes may be completed. In this example, an interfering process occurs because cfs0, 405, and mp1, 420, share a common action step 435. As such, both cfs0, 405, and mp1, 420, must wait for taska 410 to complete before proceeding individually.

While this is illustrated as a single interfering action, in practical applications many processes and services may share common, interfering, steps. Because the steps are shared between multiple processes and services, users of the processes and services may gain access to information they are not authorized to receive. The problem of interfering actions is further discussed with respect to FIG. 10.

Turning to FIG. 10, a service graph, showing processes for the system of FIG. 9 is expanded, according to one or more examples is shown. In this example, the service graph 400 of FIG. 9 is expanded to include additional services and process steps. As with FIG. 9, FIG. 10 includes cfs0, 405, and mp1, 420, which both interface with taska 410. In this expanded example, additional configurations of taska, 410, which include additional CFSs, namely, cfs1, 435, cfs2, 440, and cfs3, 445, have been added. There are now four cfs, 405, 435, 440, 445 dependent configurations under mp1, 420. All of cfs and mp1 have at least one process under taska 410 because cfs, 405, 435, 440, 445 have a cross-reference under mp1, 410, which are labeled 450, 455, 460, and 465, respectively.

Under taska 410, there are now five manual processes 470, wherein each of the process corresponds to one of the cfs, 405, 435, 440, 445 process and the mp1, 420, process. Thus, while there is a task under taska 410 that remains to be completed, as taska 410 completes the task the remaining processes continue, thereafter reporting completion to the corresponding requester when finished. Due to the reference of cfs0, 405, cfs1, 435, cfs2, 440, and cfs4, 445, all of the additional processes have become entangled within the mp1, 410 processes.

In order to prevent interfering and entangled services and process, step graphs may be generated that prevent steps that should only be owned by a first process from being owned by more than the first process. For example, by preventing a second process from owning a step that should only be owned by the first process, the step is constrained to the correct process, thereby preventing interference and entanglement that may result in security issues and/or decreased system performance.

The specific methods for generating step graphs without interfering and/or entangled process steps is discussed in detail below.

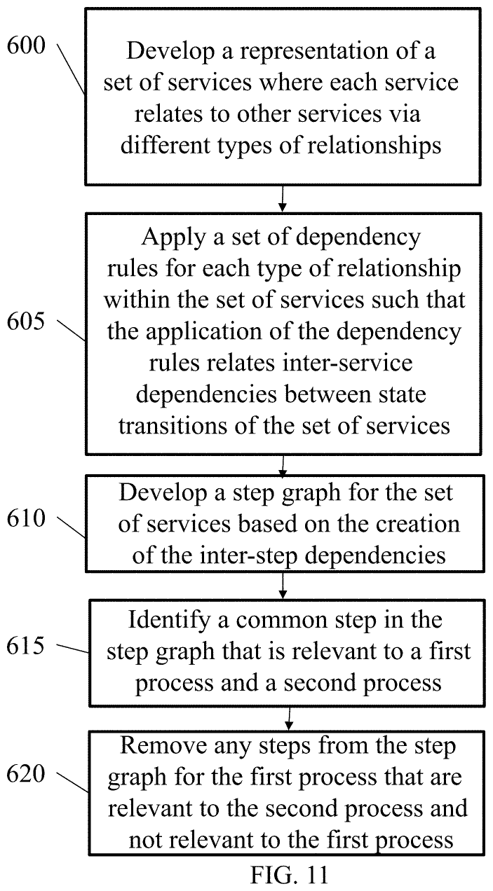

Referring now to FIG. 11, a flow diagram is illustrated in accordance with various examples of the present disclosure. The flow diagram represents processes that may be utilized in conjunction with various systems and devices as discussed with reference to the preceding figures. While illustrated in a particular order, the flow diagram is not intended to be so limited. Rather, it is expressly contemplated that various processes may occur in different orders and/or simultaneously with other processes than those illustrated. As such, the sequence of operations described in connection with FIG. 9 is an example and is not intended to be limiting. Additional or fewer operations or combinations of operations may be used or may vary without departing from the scope of the disclosed examples. Thus, the present disclosure merely sets forth possible examples of implementations, and many variations and modifications may be made to the described examples.

Turning specifically to FIG. 11, a flow diagram of a method creating an orchestration plan that prevents interferences according to one or more examples is shown. In this example, a representation is developed (600) of a set of services where each service relates to other services via different types of relationships. The specific relationships, such as those discussed above, may include parent, child, relationship, referral, prerequisite, and the like. Depending on the type of services, the graphs of the relationships may include directed acyclic graphs (“DAGs”) containing nodes and arches, as well as directed DAGs that include forests of spanning trees, with cross-references therebetween. In other implementations, the graphs may be cyclic directed graphs, that contain nodes and arcs with one or more connections, as well as cyclic directed graphs that include forests of spanning trees that contain cross-references between the nodes. Those of skill in the art having the benefit of the present disclosure will appreciate that various types of directed graphs may be used according to the implementations discussed herein.

During the development (600) of a representation, each service is modeled as related to other services by different types of relationships. In one implementation, the computing device may build a MTOSI model as input. The MTOSI model provides a representation of how each service relates to other service through types of relationships. The types of relationships include for example, a parent relationship, a child relationship, a referral relationship, a pre-requisite relationship among others. Building a model, the computing device represents the type of relationship for each service to other services which illustrates how each service relates to one another.

The method further includes applying (605) a set of dependency rules for each type of relationship within the set of services such that the application of the dependency rules creates inter-step dependencies between state transitions of the set of services. As explained above, each service may be defined as including specific inter-step dependencies, thereby preventing the execution of a specific step until completion of one or more other steps. The dependency rules may allow for the automatic generation and modification of subsequently discussed graphs, thereby making the generation and modification substantially automatic, removing the requirement that a user intervene in the graph generation. Furthermore, the dependency rules, once established, may remove the need for human intervention in approving or otherwise modifying a subsequently created orchestration plan.

The set of dependency rules may depend on the type of relationship between a given service and other services. Examples of the set of dependency rules may be possible to view state transitions that should be executed before and after a given dependency rule. This provides an indication of the set of dependency rules that may have caused the dependency between state transitions of the services. Although an example of the dependency rules is listed below, implementations should be so limiting as this was done for illustration purposes. Accordingly, there may be additional dependency rules or fewer dependency rules not listed below. For example, the set of dependency rules as grouped according to the type of relationship. For example, for a child type of relationship the dependency rules may include the following:
CHILD_SETUP—A child service/component waits for its parent to reach a given MTOSI state before the child is set-up to the same MTOSI state.
CHILD_TEARDOWN—Parent services wait to be torn down to any given MTOSI state until their child components/services are at most at that state first.
RESOURCE_TEARDOWN—The resource child waits for the parent to be TERMINATED before being torn down.

In another example, for the parent relationship the dependency rules may include the following:
PARENT_COMPLETE—The parent waits for its children to be complete, before the parent itself is marked as complete. Note that the meaning of “complete” depends on the desired state of the service.
PARENT_LOCK_STEP—If the lockstep: true option is defined in the descriptor, then the parent setup progression is waiting for the child state to be progressed lockstep according to the MTOSI state model, so that the parent state is not more than one state ahead of the child state.
PARENT_LOCK_STEPTP_TEARDOWN—If the lockstep: true option is defined in the descriptor, then the parent teardown progression is waiting for the child state to be progressed lockstep according to the MTOSI state model, so that the parent state is not more than one state higher than the child state.
RESOURCE_SETUP—A parent service waist for resources to be ACTIVE, before the parent becomes DESIGNED

In yet another example, for the reference relationship the dependency rules may include the following:
REFERENCE_SETUP—The service should wait for its reference to reach its desired state (typically ACTIVE) before progressing to RESERVED state.
REFERENCE_TEARDOWN—The referenced service is not automatically torn down until its last referrers have been torn down. Also, if the last referrer changes its reference parameter to a different service, there may be a shadow version still holding on to the old reference. So the teardown of the referenced service waits until the shadow version is removed.
SOFTREF_SETUP(p1, p2, . . . , pn)—When a prerequisite parameter (other than reference and auxreference) references a service, then the state of the referrer stays behind the state of the referenced service during setup. Note that this is different from REFERENCE_SETUP because the referenced service is not forced to become ACTIVE before the referrer; the referrer only needs to be in a lower MTOSI state. The dependency lists the names of the parameter(s) that created the dependency—so these parameters are likely candidates for a prerequisite: false annotation.
SOFTREF_TEARDOWN(p1, p2, . . . , pn)—Same as SOFTREF_SETUP, but for preventing teardown of the referenced service.
REFERENCE_LOCKSTEP—Like SOFTREF_SETUP, but holding back the state of the referenced service to stay at most one MTOSI state ahead of the referrer service. Similar to REFERENCE_TEARDOWN, but holding back the state of the referenced service to stay at most one MTOSI state larger than the state of the referrer service.
RESREF_SETUP(p1, p2, . . . , pn)—This works like softreferences, but this rule is generated instead of SOFTREF_SETUP when a parameter is specified with prerequisite: resource. With this rule, the services referenced by the listed parameters are taken to their desired state even before the current service becomes DESIGNED. So it is like REFERENCE_SETUP, but it works for any parameter and is even more restrictive. In release 2.2.1 the prerequisite; resource annotation does not work for parameters reference and auxreference.
RESREF_TEARDOWN(p1, p2, . . . , pn)—Same as RESREF_SETUP, but for preventing early teardown of the referenced service.
TRANSITION_ORDER—The sequence of state-transitions defined by the MTOSI state model.

The method also includes developing (610) a step graph for the request of the set of services based on the inter-step dependencies. The step graph may represent a part of a specific process. Certain steps may be tied to multiple services or process. As such, certain process steps may interfere with or become entangled with other services or processes.

To prevent such interference and entanglement, the method also includes identifying (615) a step in the step graph that is common to one or more processes. For example, a step may be a common step if two or more processes have subsequent steps that depend on completion of the common step. In operation, more than three processes may share a common step, and similarly, multiple processes may share multiple steps.

After identification (615) of the common step, any remaining steps from the step graph for the first process that are relevant to the second process, but not relevant to the first process may be removed (620). As discussed above, relevancy may indicate that the steps are part of or otherwise required for a particular process to complete. By removing disassociated steps, entanglement between processes may be prevented, thereby preventing the security risks discussed above. Orchestration plans for each process may then be updated and the common step may be executed. Additional methods that may be applicable to certain implementations are discussed in detail below.

In certain implementations, in order to identify (615) the common step σtopological sort of the steps is performed and for each step, a set of other steps that depend on the step is identified. For each step that the step depends on, the current process and its service and/or the current request and its service may also be identified. Accordingly, the relationship between each step and other steps may be identified so that the relative dependencies therebetween are known and may be used to identify common steps within multiple processes.

After the topological sort and identification of dependent steps, the last modified service is identified for a specific process or request. The last modified service is the last service or request for which a modification was made that may have changed the dependencies between the steps, thereby resulting in additional steps in the step graph that may be unnecessary. Such unnecessary steps may thus be interfering or entangling steps and may be removed from the process. In identifying the last modified service, if the last modified service is a process, the last modified process is used. If the last modified service is not a process, the last modified request is used. After identification of the last modified service, the first modified service that is in an ancestry relation with the process or request service is identified. For example, a parent, grandparent, child, or grandchild may be identified. One method of identifying the first modified service is by using a string that represents the path from the root of the spanning tree so that ancestry may be determined by verifying that one identifier is a prefix of the modified service. In the event no ancestral services are identified, all remaining services in the topologically sorted list are foreign and may be collected so that execution of the plan may resume.

If ancestral relationships are found, a set of services, as steps, are collected that depend on the last modified service. If there is no last modified service, the set is empty. In collecting the set, the last modified service is initially added then the parents of the last modified service are added if the parents were modified. This collection of steps that depend on the last modified service is referred to herein as the “dependsOn group”.

The steps may then be collected and divided into a dependent group and an independent group. The dependent group of steps are any steps that depend on the last modified service, while the independent group includes steps that belong to a different process or service and are thus candidates for elimination.

After the steps are collected, for each step, the following process may be performed. If the step is dependent, all steps that depend from the dependent step are added to the dependent collected group. If a step is in the dependsOn group the step is added to the dependent collected group, along with any steps the step in the depondsOn group depends on. If the step is owned by a foreign process, then the step is added to the independent group. If there are no foreign processes that accept the step, the step and any steps that depend therefrom are added to the dependent group.

At this point, if there are no independent steps, there is nothing to eliminate, and the plan may proceed. If there are independent steps, the independent steps are removed, but the foreign process and services are collected and the plan may then resume for the foreign processes.

To further explain the identification and modification of cross-referenced and potentially interfering or entangled services, the example provided in FIGS. 9 and 10 will be discussed in detail. Character references for the elements of FIGS. 9 and 10 are excluded for clarity.

As explained above, to identify and modify specific steps, all steps are initially topologically sorted. In this example, the steps include mp1.taska[O], mp1.cfs0, mp1.cfs1, mp1.cfs2, mp1.cfs3, mp1, cfs0, cfs1, cfs2, and cfs3. For each of these steps, all steps that it depends on are identified, and the current process and its service, mp1, and the current request and its service, taska, are identified.

Next, the last modified service for the process or request is identified. The last modified service, in this example, is mp1. If the last modified service was a request service, the last modified service would be taska. For the last modified service, the first modified service that has an ancestry relation is identified. While a last modified service is present in the current example, if there was not a last modified service, the remainder of the plan would consist of foreign processes. The plan could then be executed for the remaining foreign processes.

After the last modified service is identified, a set of processes are collected into a set referred to above as the dependOn group. Initially the last modified service, mp1, is added to the group, then if the service id of the process is used, the parents of mp1 are added if they were modified, then all services are added that have a parent that is a member of the dependsOn group is added. In this example, the final dependsOn group includes mp1.taska[0], mp1.cfs0, mp1.cfs1, mp1.cfs2, mp1.cfs3, and mp1.

Now the steps are collected into dependent and independent sets. In this example, the dependent steps include all steps for mp1, mp1.taska, mp1.cfs0, mp1.cfs1, mp1.cfs2, and mp1.cfs3. The independent steps include all steps for processes cfs0, cfs1, cfs2, and cfs3, while the processes themselves are foreign. Accordingly, the cross-referenced steps would include any steps that were identified as independent, including those steps related to cfs0, cfs1, cfs2, and cfs3.

Next, all steps for the independent processes, cfs0, cfs1, cfs2, and cfs3 are eliminated, and the plan for the foreign processes, cfs0, cfs1, cfs2, and cfs3 may resume. As such, by identifying potentially interfering and entangled cross-referenced services and processes, the steps associated therewith may be removed.

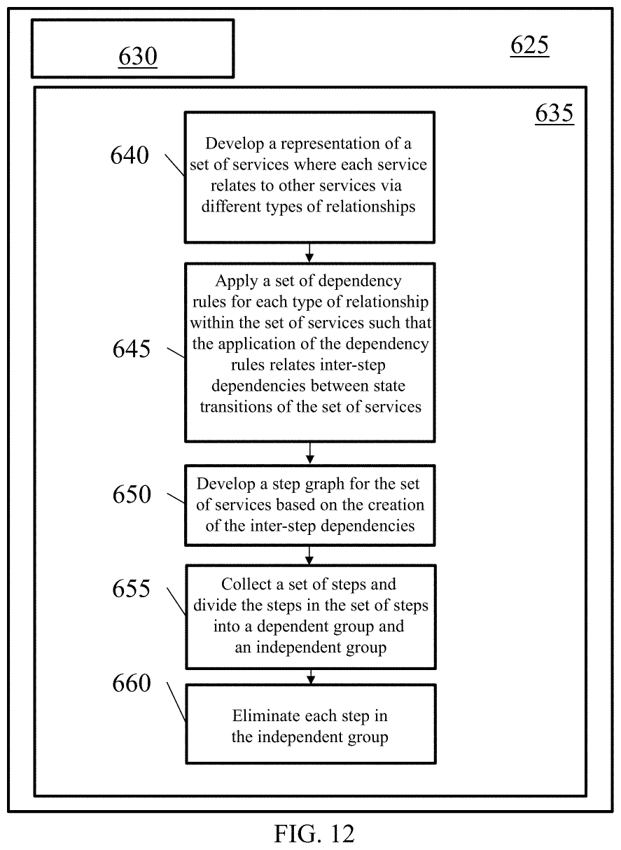

Turning to FIG. 12, an example computing device with a hardware processor and accessible machine-readable instructions is shown in accordance with one or more example embodiments. FIG. 12 provides is an example computing device 625, with a hardware processor 630, and accessible machine-readable instructions stored on a machine-readable medium 635 for performing the remote monitoring discussed above with respect to one or more disclosed example implementations. FIG. 12 illustrates computing device 625 configured to perform the flow described in blocks 600, 605 and 610, 615, and 620. Computing device 625 may also be configured to perform the flow of other methods, techniques, functions, or processes, such as those described in FIG. 11.

A machine-readable storage medium, such as 635 of FIG. 12, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (“EPROM”), random access memory (“RAM”), non-volatile random access memory (“NVRAM”), optical disk, solid state drive (“SSD”), flash memory chips, and the like. The machine-readable storage medium may be a non-transitory storage medium, where the term “non-transitory” does not encompass transitory propagating signals.

In operation, computing device 625 may develop (640) a representation of a set of service where each service relates to other services via different types of relationships. Computing device 625 may further apply (645) a set of dependency rules for each type of relationship within the set of services such that the application of the dependency rules relates inter-step dependencies between state transitions of the set of services. A step graph may then be developed (650) for the set of services based on the creation of the inter-step dependencies. Specific examples of how such representations may be developed (640), dependency rules applied (645), and step graphs developed (650) are discussed in detail with respect to FIG. 11.

In this operation, computing device 625 may then collect (655) a set of steps and divide the steps in the set of steps into a dependent group and an independent group. Each step in the independent group may then be eliminated (660), thereby preventing entanglement of external interfering actions.

In certain operations, the collection (655) of the set of steps may further include instructions to collect the set of steps based on a last modified service. In other operations, computing device 625 may also identify a step that belongs to a first process and does not belong to a second process. After identification of such a step, the step may be executed with the first process. In other implementations, the identified step may be executed with the second process or with other processes.

Computing device 625 may further include instructions to identify a common step in the step graph that is relevant to a first process and a second process. Computing device 625 may then remove any steps from the step graph for the first process that is relevant to the second process and not relevant to the first process. In other implementations, computing device 625 may include instructions to remove any steps from the step graph for a second process that is relevant to a first process and not relevant to the second process.

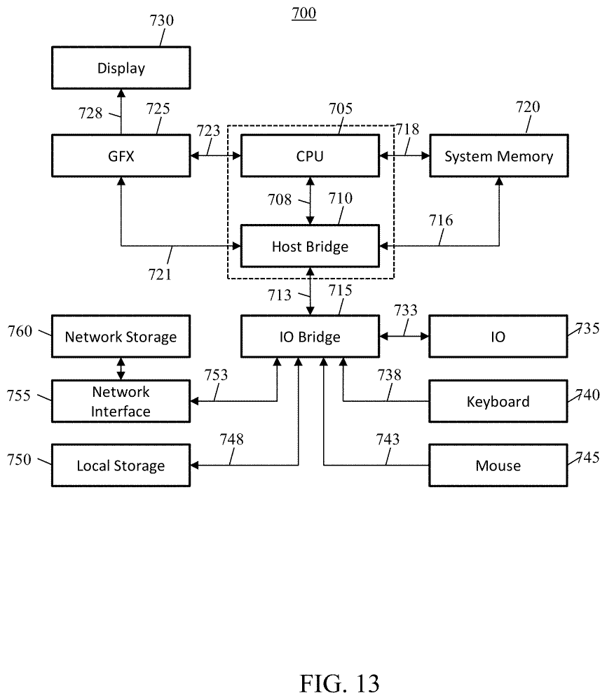

FIG. 13 shows a computing system 700 in accordance with one or more example embodiments. Computing system 700 may include one or more central processing units (singular “CPU” or plural “CPUs”) 705 disposed on one or more printed circuit boards (not otherwise shown). Each of the one or more CPUs 705 may be a single-core processor (not independently illustrated) or a multi-core processor (not independently illustrated). Multi-core processors typically include a plurality of processor cores (not shown) disposed on the same physical die (not shown) or a plurality of processor cores (not shown) disposed on multiple die (not shown) that are collectively disposed within the same mechanical package (not shown). Computing system 700 may include one or more core logic devices such as, for example, host bridge 710 and input/output (“IO”) bridge 715.

CPU 705 may include an interface 708 to host bridge 710, an interface 718 to system memory 720, and an interface 723 to one or more IO devices, such as, for example, graphics processing unit (“GFX”) 725. GFX 725 may include one or more graphics processor cores (not independently shown) and an interface 728 to display 730. In certain embodiments, CPU 705 may integrate the functionality of GFX 725 and interface directly (not shown) with display 730. Host bridge 710 may include an interface 708 to CPU 705, an interface 713 to IO bridge 715, for examples where CPU 705 does not include interface 718 to system memory 720, an interface 716 to system memory 720, and for examples where CPU 705 does not include integrated GFX 725 or interface 723 to GFX 725, an interface 721 to GFX 725. One of ordinary skill in the art will recognize that CPU 705 and host bridge 710 may be integrated, in whole or in part, to reduce chip count, motherboard footprint, thermal design power, and power consumption. IO bridge 715 may include an interface 713 to host bridge 710, one or more interfaces 733 to one or more IO expansion devices 735, an interface 738 to keyboard 740, an interface 743 to mouse 745, an interface 748 to one or more local storage devices 750, and an interface 753 to one or more network interface devices 755.

Each local storage device 750 may be a solid-state memory device, a solid-state memory device array, a hard disk drive, a hard disk drive array, or any other non-transitory computer readable medium. Each network interface device 755 may provide one or more network interfaces including, for example, Ethernet, Fibre Channel, WiMAX, Wi-Fi, Bluetooth, or any other network protocol suitable to facilitate networked communications. Computing system 700 may include one or more network-attached storage devices 760 in addition to, or instead of, one or more local storage devices 750. Network-attached storage device 760 may be a solid-state memory device, a solid-state memory device array, a hard disk drive, a hard disk drive array, or any other non-transitory computer readable medium. Network-attached storage device 760 may or may not be collocated with computing system 00 and may be accessible to computing system 700 via one or more network interfaces provided by one or more network interface devices 755.

One of ordinary skill in the art will recognize that computing system 700 may include one or more application specific integrated circuits (“ASICs”) that are configured to perform a certain function, such as, for example, hashing (not shown), in a more efficient manner. The one or more ASICs may interface directly with an interface of CPU 705, host bridge 760, or IO bridge 715. Alternatively, an application-specific computing system (not shown), sometimes referred to as mining systems, may be reduced to only those components necessary to perform the desired function, such as hashing via one or more hashing ASICs, to reduce chip count, motherboard footprint, thermal design power, and power consumption. As such, one of ordinary skill in the art will recognize that the one or more CPUs 705, host bridge 710, IO bridge 715, or ASICs or various sub-sets, super-sets, or combinations of functions or features thereof, may be integrated, in whole or in part, or distributed among various devices in a way that may vary based on an application, design, or form factor in accordance with one or more example embodiments. As such, the description of computing system 700 is merely exemplary and not intended to limit the type, kind, or configuration of components that constitute a computing system suitable for performing computing operations, including, but not limited to, hashing functions. Additionally, one of ordinary skill in the art will recognize that computing system 600, an application specific computing system (not shown), or combination thereof, may be disposed in a standalone, desktop, server, or rack mountable form factor.

One of ordinary skill in the art will recognize that computing system 700 may be a cloud-based server, a server, a workstation, a desktop, a laptop, a netbook, a tablet, a smartphone, a mobile device, and/or any other type of computing system in accordance with one or more example embodiments.

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

While the present teachings have been described in conjunction with various examples, it is not intended that the present teachings be limited to such examples. The above-described examples may be implemented in any of numerous ways.

Also, the technology described herein may be embodied as a method, of which at least one example has been provided. The acts performed as part of the method may be ordered in any suitable way. Accordingly, examples may be constructed in which acts are performed in an order different than illustrated, which may include performing some acts simultaneously, even though shown as sequential acts in illustrative examples.

Advantages of one or more example examples may include one or more of the following:

In one or more examples, systems and methods disclosed herein may be used to increase processing speed executing nondependent services in a service set.

In one or more examples, systems and methods disclosed herein may be used to decrease the time for executing a plan.

Not all examples will necessarily manifest all these advantages. To the extent that various examples may manifest one or more of these advantages, not all of them will do so to the same degree.

While the claimed subject matter has been described with respect to the above-noted embodiments, those skilled in the art, having the benefit of this disclosure, will recognize that other examples may be devised that are within the scope of claims below as illustrated by the example examples disclosed herein. Accordingly, the scope of the protection sought should be limited only by the appended claims.

What is claimed is:

1. A method comprising:
developing a representation of a set of services where each service relates to other services via different types of relationships;
applying a set of dependency rules for each type of relationship within the set of services such that the application of the dependency rules creates inter-step dependencies between state transitions of the set of services;
developing a step graph for the set of services based on the inter-step dependencies;
identifying a common step in the step graph that is relevant to a first process and a second process; and
removing any steps from the step graph for the first process that are relevant to the second process and not relevant to the first process.

2. The method of claim 1, further comprising completing the common step.

3. The method of claim 1, further comprising identifying a last modified service from the set of services.

4. The method of claim 3, further comprising collecting a set of steps based on the last modified service and dividing the steps in the set of steps into a dependent group, and an independent group.

5. The method of claim 4, further comprising eliminating each step in the independent group.

6. The method of claim 5, further comprising removing each step from the step graph for the second process that is relevant to the first process and not relevant to the second process.

7. The method of claim 1, further comprising developing an orchestration plan based on the step graph.

8. The method of claim 1, wherein modifying the step comprises moving the cross-referenced step to a different location within the step graph.

9. A non-transitory computer readable medium comprising computer executable instructions stored thereon that when executed by one or more processing units perform a method to prevent interferences in an orchestration plan, the method comprising instructions to:
develop a representation of a set of services where each service relates to other services via different types of relationships;
apply a set of dependency rules for each type of relationship within the set of services such that the application of the dependency rules creates inter-step dependencies between state transitions of the set of services;
develop a step graph for the set of services based on the creation of the inter-step dependencies;
collect a set of steps and divide the steps in the set of steps into a dependent group and an independent group; and
eliminate each step in the independent group.

10. The method of claim 9, wherein the instructions to collect a set of steps comprises instructions to collect the set of steps based on a last modified service.

11. The method of claim 9, further comprising instructions to identify a step that is relevant to a first process and is not relevant to a second process and execute the step with the first process.

12. The method of claim 9, further comprising instructions to identify a common step in the step graph that is relevant to a first process and a second process.

13. The method of claim 12, comprising instructions to remove any steps from the step graph for the first process that are relevant to the second process and not relevant to the first process.

14. The method of claim 9 further comprising instructions to remove any steps from the step graph for the second process that are relevant to the first process and not relevant to the second process.

15. A system comprising:
a modeler that develops a representation of a set of services, wherein each service relates to other services via different types of relationships;
a planner connected to the modeler and a processor that applies a set of dependency rules for each type of relationship between each service and other services and based on the application of the set of dependency rules, creates inter-step dependencies between a state transition of each service and other state transitions of the other services, and based on the inter-step dependencies, develops a step graph for the set of services based, on the creation of the inter-service dependencies, identifies a common step in the step graph that is relevant to a first process and a second process, and removes any steps from the step graph for the first process that are relevant to the second process and not relevant to the first process.

16. The method of claim 15, wherein the planner further performs a topological sort of a plurality of steps in the step graph and identifies, for each step, a set of other steps that the step depends on.

17. The method of claim 16, wherein the planner further identifies a last modified service from the set of services.

18. The method of claim 17, wherein the planner further collects a set of steps based on the last modified service and divides the steps in the set of steps into a dependent group and an independent group.

19. The method of claim 18, wherein each step in the independent group is eliminated.

20. The method of claim 19, wherein the system completes the common step.
